(19) United States
(12) Patent Application Publication
(10) Pub. No.: US 2015/0222161 A1
(43) Pub. Date: Aug. 6, 2015

(54) DEVICE COMPRISING AN ELECTRIC MACHINE WITH A LIGHTWEIGHT DESIGN

(71) Applicant: SIEMENS AKTIENGESELLSCHAFT, München (DE)

(72) Inventors: Christian Ballauf, Munchen (DE); Zeljko Jajtic, Munchen (DE); Gerhard Matscheko, Starnberg (DE)

(73) Assignee: SIEMENS AKTIENGESELLSCHAFT, Munchen (DE)

(21) Appl. No.: 14/426,395

(22) PCT Filed: Sep. 3, 2013
(86) PCT No.: PCT/EP2013/068166

§ 371 Date: Mar. 6, 2015

(30) Foreign Application Priority Data
Sep. 13, 2012 (EP) 12184264.5

(51) Int. Cl. H02K 9/19; H02K 9/02

(52) U.S. Cl. CPC H02K 9/19; H02K 9/02

(57) ABSTRACT

A machine comprising a base body and an electric machine is provided. The electric machine includes a stator pack and a rotor. The rotor is mounted in a bearing device relative to the stator pack so that the rotor can be rotated about a rotational axis relative to the stator pack. The rotor is embodied as an outer rotor such that the stator pack is arranged between the rotor and the rotational axis when seen radially with respect to the rotational axis. The base body is arranged at least partially radially inside the stator pack. The stator pack is thermally coupled to a cooling device such that heat produced in the stator pack is transferred in the cooling device.

### CROSS-REFERENCE TO RELATED APPLICATIONS

This application claims priority to PCT Application No. PCT/EP2013/068166, having a filing date of Sep. 3, 2013, based on EP 12184264.5 having a filing date of Sep. 13, 2012, the entire contents of which are hereby incorporated by reference.

### FIELD OF TECHNOLOGY

The following relates to a device, wherein the device has a basic body and an electric machine, wherein the electric machine has a stator stack and a rotor, wherein the rotor is mounted relative to the stator stack in a bearing device so that the rotor is rotatable about an axis of rotation relative to the stator stack, wherein the rotor is in the form of an external rotor so that, when viewed radially with respect to the axis of rotation, the stator stack is arranged between the rotor and the axis of rotation, wherein the basic body is arranged at least partially radially within the stator stack, wherein the stator stack is thermally coupled to a cooling device so that heat produced in the stator stack is introduced into the cooling device, wherein the heat introduced into the cooling device is dissipated out of the cooling device by means of cooling air flowing axially through the cooling device.

### BACKGROUND

In the context of mobile applications, the power-to-weight ratio of electric motors is very important. In particular, attempts are made to reduce the weight of the electric motors as much as possible. It is desirable to reduce weight both in the case of the so-called active parts (i.e. the electromagnetically active components, i.e. magnets and windings and laminations or laminate stacks) and in the case of the remaining components, the so-called passive parts.

Attempts are generally made in the prior art to optimize the individual components of the systems. However, a particularly high degree of potential lies in integrative lightweight construction, for example by structural and functional integration of active and passive parts.

### SUMMARY

The object of the present invention consists in providing An aspect relates to a device comprising an electric machine with a lightweight design, in which such an integrative lightweight construction is realized efficiently.

In accordance with embodiments of the invention, a device of the type mentioned at the outset is developed further in that the stator stack is connected to a basic body arranged radially within the stator stack via the cooling device so that the stator stack is fixed axially and radially relative to the basic body by means of the cooling device and a torque acting between the stator stack and the rotor is supported on the basic body by means of the cooling device.

In accordance with embodiments of the invention, therefore, the cooling device at the same time forms the supporting structure which connects the stator stack to the basic body.

In general, the cooling device is the only cooling device of the electric machine. The electric machine therefore does not have a further cooling device apart from the abovementioned cooling device.

In general, the stator stack has a minimum spacing from the axis of rotation. In a preferred configuration of the present invention, the stator stack is thermally coupled to the cooling device by means of electromagnetically inactive coupling elements, some of which have a spacing from the axis of rotation which is greater than the minimum spacing and some of which have a spacing which is less than the minimum spacing. The coupling elements therefore represent a type of bridge, via which the heat produced in the stator stack is introduced into the cooling device.

There are various possibilities for the configuration of the coupling elements. One possible example consists in that the stator stack has a number of stator laminations, which are stacked one on top of the other, when viewed in the direction of the axis of rotation, in that the coupling elements, if they have a spacing from the axis of rotation that is greater than the minimum spacing, are in the form of interlayers arranged between in each case two of the stator laminations, and in that the interlayers extend integrally beyond the minimum spacing into the region of the cooling device.

The material of the interlayers can be selected as required. For example, the interlayers can consist of a plastic, in particular of a fiber composite material. Suitable fiber composite materials are, for example, carbon fiber-reinforced plastic (CFRP) or glass fiber-reinforced plastic (GFRP).

As an alternative or in addition, it is possible for the interlayers to consist of a material which has a preferred heat-conducting direction. Such materials, in particular carbon fiber-reinforced plastics, are known to those skilled in the art. In this case, the preferred heat-conducting direction is preferably oriented radially both within the stator stack and outside of the stator stack.

Alternatively, it is possible for the interlayers to consist of a metal.

Preferably, provision is made for the cooling device to have a number of substructures, for the substructures to each have a central layer which does not contain any of the interlayers, and for the central layers to be delimited in each case on both sides by a group of interlayers, when viewed in the direction of the axis of rotation. By virtue of this configuration, a very stable cooling device which can be subjected to loads results in a particularly simple manner.

The number of first interlayers per group of interlayers can be as required. It is possible for the corresponding number to be equal to one. Alternatively, it is possible for the corresponding number to be greater than one, for example three to six.

The central layers can be formed as required. For example, it is possible for the central layers to consist of a structural foam. Alternatively, the central layers can consist of a sandwich structure. In this case, the sandwich structure preferably has two covering layers and one honeycomb structure arranged between the covering layers.

As an alternative to the design of the coupling elements as interlayers, it is possible for the coupling elements to be in the form of cooling lines, which extend partially in the stator stack and partially in the cooling device or open out into the cooling device and which contain a liquid cooling medium. By virtue of this configuration, a light and compact liquid-cooled electric machine can be realized in a simple manner.

In the case of liquid cooling, the device preferably has a cooling medium pump, by means of which the cooling medium contained in the cooling lines is forcibly circulated.

Preferably, the cooling device is in the form of a lattice structure over the whole area, when viewed transversely to the axis of rotation. This results in particularly high cooling performance.

The device according to embodiments of the invention can moreover be designed as required. However, particularly preferred is an application in the sector of aeronautics, i.e. when the basic body is part of an aircraft, in particular a helicopter.

### BRIEF DESCRIPTION

Some of the embodiments will be described in detail, with reference to the following figures, wherein like designations denote like members, wherein:

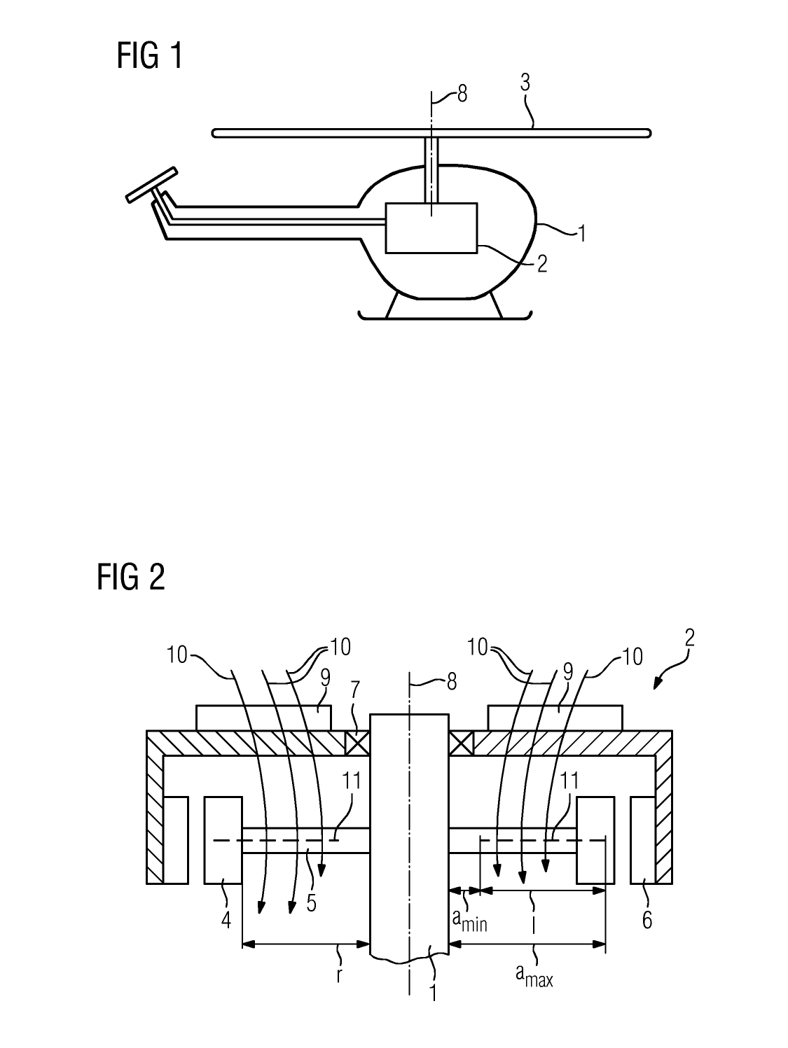

FIG. 1 shows a device comprising an embodiment of an electric machine;

FIG. 2 shows a longitudinal section through an embodiment of an electric machine;

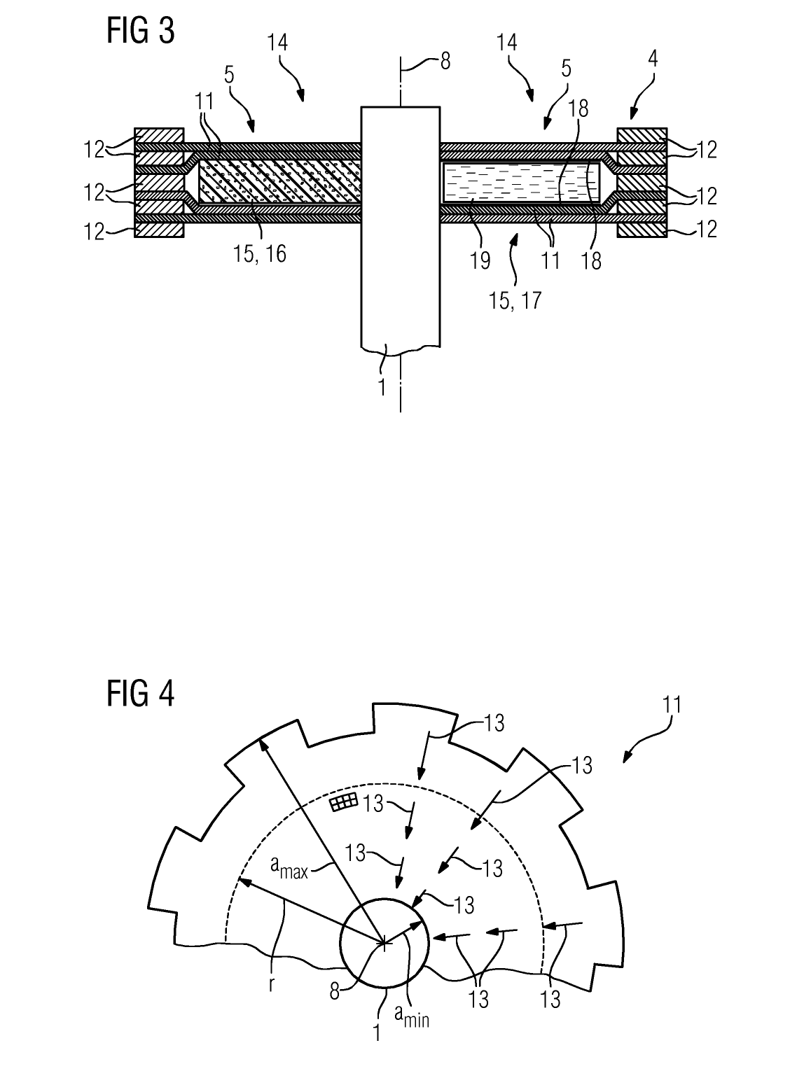

FIG. 3 shows embodiments of a stator stack and a cooling device;

FIG. 4 shows a plan view of an embodiment of an interlayer;

FIG. 5 shows a more detailed longitudinal section through an embodiment of an electric machine and

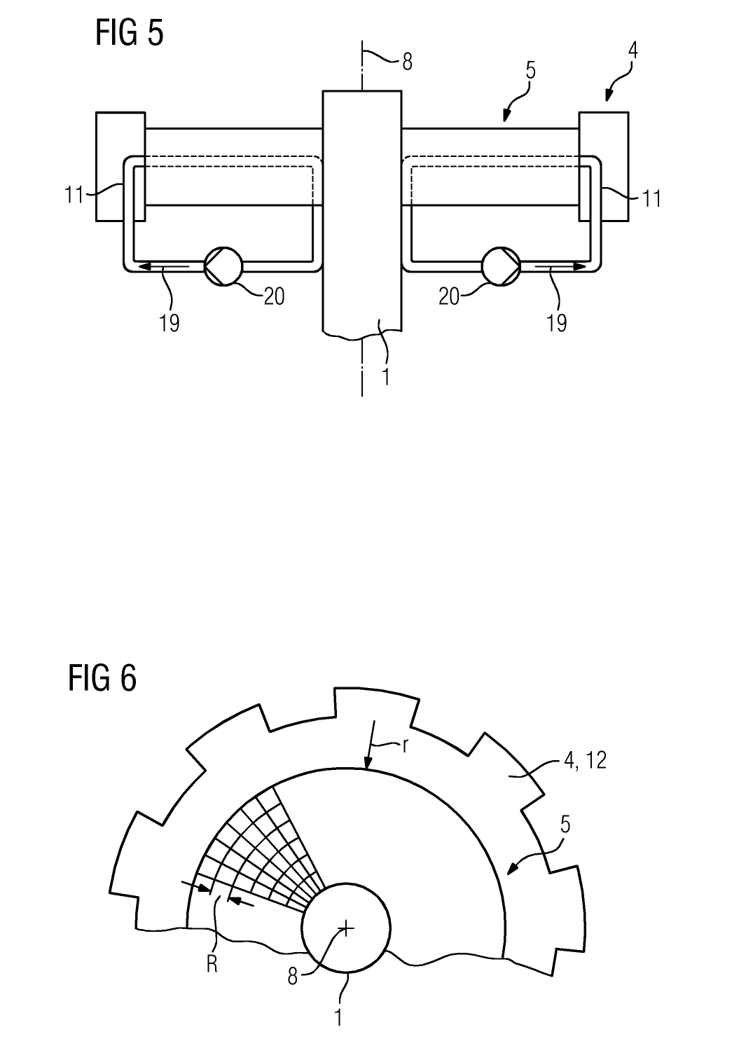

FIG. 6 shows a plan view of an embodiment of a cooling device.

### DETAILED DESCRIPTION

As shown in FIG. 1, a device, in principle any desired device, has a basic body 1. As shown in FIG. 1, the basic body 1 is part of an aircraft, namely a helicopter. However, this illustration is purely by way of example. In principle, the basic body 1 could have any desired configuration.

An electric machine 2 is arranged in or on the basic body 1. The electric machine 2 drives a generator set 3 of the device. In particular, the electric machine 2 can be in the form of the main drive for the device. In the case of an aircraft, the generator set 3 is in the form of an airscrew generating propulsion and/or uplift for example. The word “rotor” in this connection is avoided intentionally because it is required later as such in connection with the electric machine 2.

As shown in FIG. 2, the electric machine 2 has a stator stack 4. The stator stack 4 is connected to the basic body 1 via a cooling device 5, as shown in FIG. 2. The cooling device 5 will be explained in more detail later.

The electric machine 2 furthermore has a rotor 6. The rotor 6 interacts electromagnetically with the stator stack 4. Therefore, the electromotive force is formed between the stator stack 4 and the rotor 6. The rotor 6 is mounted in (at least) one bearing device 7 so that the rotor 6 is rotatable about an axis of rotation 8.

Where the terms “axial”, “radial” and “tangential” are used below, they always relate to the axis of rotation 8. Axial is a direction parallel to the axis of rotation 8. Radial is a direction orthogonal to the axis of rotation 8 towards the axis of rotation 8 or away from the axis of rotation 8. Tangential is a direction orthogonal to the axis of rotation 8 and orthogonal to the radial direction. Tangential is therefore a direction which is directed in the form of a circle around the axis of rotation 8 with a constant radial spacing and a constant axial position.

As shown in FIG. 2, the rotor 6 is in the form of an external rotor. The stator stack 4 is therefore arranged in the same axial position as the rotor 6, but when viewed radially with respect to the axis of rotation 8, the stator stack 4 is arranged between the rotor 6 and the axis of rotation 8.

The stator stack 4 is thermally coupled to the cooling device 5. Heat produced during the operation of the electric machine 2 in the stator stack 4 is therefore introduced into the cooling device 5. Corresponding possibilities for the coupling of the stator stack 4 to the cooling device 5 will be explained in more detail later.

As shown in FIG. 2, the rotor 6 has fan blades 9. Cooling air 10 is supplied in the axial direction to the cooling device 5.

By means of the fan blades 9 during operation of the electric machine 2, i.e. during rotation of the rotor 6. The supplied cooling air 10 flows through the cooling device 5. The heat introduced into the cooling device 5 is dissipated from the cooling device 5 by means of the cooling air 10. As an alternative to forced ventilation, however, heat dissipation out of the cooling device 5 by natural convection is also possible, in particular in the case of a vertical orientation of the axis of rotation 8.

As shown in FIG. 2, the stator stack 4 is connected to the basic body 1 via the cooling device 5. The basic body 1 is arranged radially within the stator stack 4, as shown in FIG. 2. The cooling device 5 therefore extends, starting from the stator stack 4, radially inwards towards the axis of rotation 8. The stator stack 4 is fixed axially and radially relative to the basic body 1 by means of the cooling device 5. A torque acting between the stator stack 4 and the rotor 6 during operation of the electric machine 2 is supported on the basic body 1 by means of the cooling device 5. The cooling device 5 therefore serves not only to cool the stator stack 4, but also acts as a structure supporting the stator stack 4.

The cooling device 5 is preferably the only cooling device of the electric machine 2. Apart from the cooling device 5, the electric machine 2 therefore preferably does not have any further cooling device.

Possible configurations of the coupling of the stator stack 4 to the cooling device 5 will be explained in more detail below.

As shown in FIG. 2, the stator stack 4 has a minimum spacing r from the axis of rotation 8. In order to be able to introduce the heat produced in the stator stack 4 into the cooling device 5 efficiently, the stator stack 4 is thermally coupled to the cooling device 5 by means of coupling elements 11. The coupling elements 11 are electromagnetically inactive. The coupling elements 11 extend in the radial direction over a specific length 1. Owing to their lengthwise extent, the coupling elements 11 have a spacing from the axis of rotation 8 which is between a minimum value amin and a maximum value amax, depending on what point of the coupling elements 11 is considered. The minimum spacing r of the stator stack 4 is between the minimum value amin and the maximum value amax. In other words: some of the coupling elements 11 have a spacing from the axis of rotation 8 which is greater than the minimum spacing r, and some of the coupling elements 11 have a spacing which is less than the minimum spacing r. Possible configurations of the coupling elements 11 will be explained in more detail below in conjunction with the further Figures.

The stator stack 4 has, as is generally conventional, a number of stator laminations 12. The stator laminations 12 are stacked one on top of the other, when viewed in the direction of the axis of rotation 8. If the coupling elements 11 have a spacing from the axis of rotation 8 which is greater than the minimum spacing r, they are arranged in the region of the stator stack 4. It is possible, as shown in FIG. 3, for the coupling elements 11 to be in the form of interlayers in this region, which interlayers are arranged between in each case two of the stator laminations 12. In this case, the interlayers 11 extend integrally beyond the minimum spacing r into the region of the cooling device 5.

The interlayers 11 can consist of a (nonmagnetic) metal, for example aluminum or copper. Alternatively, the interlayers 11 can consist of a plastic, for example, in particular a fiber composite material. Suitable fiber composite materials are, for example, carbon fiber-reinforced plastics or glass fiber-reinforced plastics.

It is possible for the interlayers 11 to consist of a material which has a preferred heat-conducting direction. For example, some carbon fiber-reinforced plastics have such a property. If the interlayers 11 consist of such a material, the preferred heat-conducting direction 13 is preferably oriented radially both within the stator stack 4 and outside of the stator stack 4. FIG. 4 shows a corresponding possible configuration.

As shown in FIG. 4, the interlayer 11 consists substantially of solid material in the region of the stator stack 4. In the region of the cooling device 5, the interlayer 11 has a lattice structure, however. Further details will be given later in this regard.

Ss shown in FIG. 3, the cooling device 5 has a number of substructures 14. As a minimum, a single substructure 14 is provided. Alternatively, the number of substructures 14 can be greater than one. The substructures 14 each have a central layer 15. The central layers 15 do not contain any of the interlayers 11. The central layers 15 are delimited in each case on both sides axially by a group of interlayers 11.

The central layers 15 can consist of a structural foam 16, for example. This is illustrated on the left-hand side in FIG. 3. Alternatively, the central layers 15 can consist of a sandwich structure 17. This is illustrated on the right-hand side in FIG. 3. The sandwich structure 17 for its part has two covering layers 18 and a honeycomb structure 19, if such a sandwich structure is provided at all. The covering layers 18 each adjoin one of the groups of interlayers 11.

The number of interlayers 11 per group of interlayers 11 can be selected as required. It can be one or greater than one, for example between three and six, as shown in FIG. 3.

In general, a plurality of substructures 14 is provided. It is possible for the substructures 14 to merge with one another, when viewed in the direction of the axis of rotation 8, i.e. for a group of first interlayers 11 to simultaneously adjoin two central layers 15.

As an alternative to a configuration as interlayers, the coupling elements 11 shown in FIG. 5 can be in the form of cooling lines. In this case, the cooling lines 11 extend partially in the stator stack 4 and partially in the cooling device 5, as shown in FIG. 5. As an alternative to an extent in the cooling device 5, they can also open out into the cooling device 5. A liquid cooling medium 19, for example water, is contained in the cooling lines 11. It is particularly preferred if a cooling medium pump 20 is included in the cooling medium cycle. It is therefore preferred for the device to have the cooling medium pump 20 and for the cooling medium 19 contained in the cooling lines 11 to be forcibly circulated by means of the cooling medium pump 20.

In order to optimize the cooling performance that can be achieved, i.e. the quantity of heat that can be dissipated out of the cooling device 5, the cooling device 5 is preferably in the form of a lattice structure over the entire area, when viewed transversely to the axis of rotation 8, corresponding to the illustration in FIG. 6. A desirable pitch R of the lattice structure should firstly be small enough in order to ensure a large surface area for the cooling air 10. Secondly, the pitch R should be large enough in order not to impede the passage of cooling air 10 through the lattice structure. In tests and simulations, it has proven to be advantageous if the pitch R is between 4×4 mm and 10×10 mm. The lattice structure can in this case be square. Alternatively, rectangular, polygonal (for example honeycomb-shaped) or other cross sections are also possible.

Embodiments of the present invention have many advantages. In particular, a relatively simple, inexpensive, space-saving and furthermore very light solution for an electric machine 2 can be provided by the integration of the supporting function in the cooling device 5.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A device, comprising:
a basic body and an electric machine; the electric machine having a stator stack and a rotor, the rotor mounted relative to the stator stack in a bearing device so that the rotor is rotatable about an axis of rotation relative to the stator stack;
wherein the rotor is an external rotor so that, when viewed radially with respect to the axis of rotation, the stator stack is arranged between the rotor and the axis of rotation;
wherein the basic body is arranged at least partially radially within the stator stack;
wherein the stator stack is thermally coupled to a cooling device so that heat produced in the stator stack is introduced into the cooling device;
wherein the heat introduced into the cooling device is dissipated out of the cooling device by means of cooling air flowing axially through the cooling device;
wherein the stator stack is connected to the basic body via the cooling device so that the stator stack is fixed axially and radially relative to the basic body by means of the cooling device and a torque acting between the stator stack and the rotor is supported on the basic body by means of the cooling device.

2. The device as claimed in claim 1, wherein the electric machine does not have any further cooling device.

3. The device as claimed in claim 1, wherein the stator stack has a minimum spacing from the axis of rotation, in that the stator stack is thermally coupled to the cooling device by means of electromagnetically inactive coupling elements, and in that some of the electromagnetically inactive coupling elements have a spacing from the axis of rotation that is greater than the minimum spacing and some of the electromagnetically inactive coupling elements have a spacing which is less than the minimum spacing.

4. The device as claimed in claim 3, wherein the stator stack has a plurality of stator laminations, which are stacked one on top of the other, when viewed in the direction of the axis of rotation, in that the electromagnetically inactive coupling elements, if they have a spacing from the axis of rotation that is greater than the minimum spacing, are in the form of interlayers arranged between in each case two of the plurality of stator laminations, and in that the interlayers extend integrally beyond the minimum spacing into the region of the cooling device.

5. The device as claimed in claim 4, wherein the interlayers comprise a plastic.

6. The device as claimed in claim 4, wherein the interlayers comprise a material which has a preferred heat-conducting direction, and in that the preferred heat-conducting direction is oriented radially both within the stator stack and outside of the stator stack.

7. The device as claimed in claim 4, wherein the interlayers comprise a metal.

8. The device as claimed in claim 4, wherein the cooling device has a plurality of substructures, in that the plurality of substructures each have a central layer which does not contain any of the interlayers, and in that the central layers are delimited in each case on both sides by a group of interlayers, when viewed in the direction of the axis of rotation.

9. The device as claimed in claim 8, wherein the central layers comprise at least one of a structural foam and a sandwich structure, wherein the sandwich structure has two covering layers and a honeycomb structure arranged between the covering layers.

10. The device as claimed in claim 3, wherein the electromagnetically inactive coupling elements are in the form of cooling lines, which extend partially in the stator stack and partially in the cooling device or open out into the cooling device and which contain a liquid cooling medium.

11. The device as claimed in claim 10, wherein the device has a cooling medium pump, by means of which the cooling medium contained in the cooling lines is forcibly circulated.

12. The device as claimed in claim 1, wherein the cooling device is in the form of a lattice structure over the whole area, when viewed transversely to the axis of rotation.

13. The device as claimed in claim 1, wherein the basic body is part of an aircraft, in particular a helicopter.

14. The device as claimed in claim 4, wherein the interlayers are comprised of a fiber composite material.

15. The device as claimed in claim 1, wherein the basic body is part of a helicopter.
